(19) United States
(12) Patent Application Publication
(10) Pub. No.: US 2024/0299829 A1
(43) Pub. Date: Sep. 12, 2024

(54) VOICE COMMAND SYSTEM AND METHOD FOR EXERCISE SYSTEM

(71) Applicant: I-TECH USA, INC., Farmington Hills, MI (US)

(72) Inventor: Dong Un Kim, Northville, MI (US)

(21) Appl. No.: 18/601,357

(22) Filed: Mar. 11, 2024

Related U.S. Application Data
(60) Provisional application No. 63/489,203, filed on Mar. 9, 2023.

(51) Int. Cl. A63B 71/06; A63B 24/00; G06F 3/16; G10L 15/22

(52) U.S. Cl. CPC A63B 71/06; A63B 24/0087; G06F 3/167; G10L 15/22; A63B 2071/068; G10L 2015/223

(57) ABSTRACT

An exercise device system having a voice command and methods for using a voice command system of an exercise system by a user are provided. The exercise system can include a knob, a motor, firmware, and the voice command system. The voice command system can include a voice capture module and an instruction module. The voice capture module can be configured to capture a voice command or user instruction for the new workout setting. The instruction module can be configured to provide the voice command to the firmware to adjust the knob from the current workout setting to the new workout setting when the current workout setting and the new workout setting are different. The method can include at least one of increasing resistance, decreasing resistance, and selecting a preprogrammed cycle.

### CROSS-REFERENCE TO RELATED APPLICATIONS

This application claims the benefit of U.S. Provisional Application No. 63/489,203, filed on Mar. 9, 2023. The entire disclosure of the above application is incorporated herein by reference.

### FIELD

The present technology relates to a voice command system, and more particularly, a voice command system for an exercise system.

### INTRODUCTION

This section provides background information related to the present disclosure which is not necessarily prior art.

The area of fitness technology has seen significant advancements in recent years, with a focus on integrating digital interfaces and interactive features into exercise equipment. Prior to the current advancements, exercise machines were primarily mechanical, with limited electronic features such as digital displays for tracking workout metrics like time, distance, and calories burned. Users had to manually adjust settings such as resistance levels, which could interrupt the flow of their workout.

The introduction of smart fitness equipment brought a new level of interactivity and personalization to workouts. These smart devices often include touchscreens and internet connection capabilities, allowing users to access a variety of workout programs, track their progress over time, and even compete with other users. However, interaction with these devices still requires physical contact, which can be inconvenient and disruptive during intense exercise sessions.

Voice recognition technology can be incorporated into various consumer electronics, enabling hands-free operation and enhancing user convenience. In the context of fitness equipment, however, the application of voice command technology has been limited. While some systems allow users to start or stop workouts with voice commands, the ability to make fine-tuned adjustments or navigate complex menus through voice is not yet fully realized.

Integration of artificial intelligence (AI) into voice recognition systems has also marked a turning point in the evolution of user interfaces. AI-enabled devices can understand natural language commands and learn from user interactions, leading to more accurate and responsive voice command systems. Despite these advancements, the fitness industry has been slow to adopt AI-powered voice command features that could seamlessly integrate with the physical components of exercise equipment.

The use of sensors and firmware in exercise equipment has also progressed. Examples include the implementation of components like potentiometers and hall sensors to precisely measure and adjust various settings. These technologies have enabled more accurate control over equipment settings but can require manual operation or rudimentary electronic interfaces.

Accordingly, there is a continuing need for a fully integrated voice command system that can not only understand and process complex voice instructions but also translate such instructions into precise mechanical adjustments on fitness equipment.

### SUMMARY

In concordance with the instant disclosure, a fully integrated voice command system that recognizes and processes voice instructions and translates voice instructions into mechanical adjustments on fitness equipment, has surprisingly been discovered. The present technology includes articles of manufacture, systems, and processes that relate to a voice command system and use thereof with an exercise system. Also provided are ways for configuring and using a voice command system for an exercise system.

An exercise system having a voice command system is provided. The exercise system can include a knob, a motor, firmware, and the voice command system. The motor can be configured to adjust the knob. The firmware can be configured to ascertain a difference between a new workout setting and a current workout setting. The voice command system can include a voice capture module and an instruction module. The voice capture module can be configured to capture a voice command or user instruction for the new workout setting. The instruction module can be in communication with the voice capture module and the firmware. The instruction module can be configured to provide the voice command to the firmware to adjust the knob from the current workout setting to the new workout setting when the current workout setting and the new workout setting are different.

The present disclosure also provides a method for using a voice command system of an exercise system by a user. The method can include a step of providing the exercise system and a step of providing the voice command system for the exercise system. The method can include a step of performing a current workout with the exercise system by the user and a step of instructing the exercise system with a voice command to initiate a new workout. The method can include a step of performing a new workout with the exercise system.

In certain embodiments, a method for using a voice command system of an exercise system by a user is provided, where the method can include a step of using a voice command to move the exercise system from a current workout setting to a new workout setting. The method can include providing the exercise system including the voice command system for an exercise system as described herein. The method can include a step of instructing the exercise system with a voice command. The voice command can be captured by the voice capture module of the exercise system. The method can include the steps of activating the AI chip to process and communicate the voice command to the instruction module. The method can include a step of determining the position of a knob of the exercise system relative to the current workout setting. The method can further include the steps of rotating a knob using a motor of the exercise system and thereby rotating the position of the knob relative to the new workout setting and communicating to the user interface that the knob has moved from the current workout setting to the new workout setting.

In certain embodiments, the method can include a step of prompting the user to select a preprogrammed cycle, weight and duration of the selected preprogrammed cycle. The method can include selecting a preprogrammed cycle and also include playing an instructional video corresponding to the selected preprogrammed cycle. The user can proceed with working out according to the instructional video.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1A is a block diagram depicting a voice command system in use with an exercise system, according to an embodiment of the present disclosure;

FIG. 1B is a block diagram depicting a voice command system in use with an exercise system, according to another embodiment of the present disclosure;

FIG. 2 is a flow diagram depicting a method for using a voice command system of an exercise system by a user, according to an embodiment of the present disclosure;

FIGS. 3A-3B provide a flow diagram depicting a method for using a voice command system to increase resistance of an exercise system by a user;

FIGS. 4A-4B provide a flow diagram depicting a method for using a voice command system to decrease resistance of an exercise system by a user;

FIG. 5 is a flow diagram depicting a method for using a voice command system where an impossible voice command is provided by a user; and

FIGS. 6A-6D provide a flow diagram depicting a method for using a voice command system to initiate a pre-programmed workout of an exercise system by a user.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one clement or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology relates to an exercise system having a voice command system. The exercise system can include a knob, a motor, and firmware. The voice command system can include a voice capture module and an instruction module. The voice command system can also include a user interface module. It should be appreciated that the exercise system can include other operational parts such as the ones found in U.S. Patent Application Pub. No. 2023/0001259 titled FULL BODY FITNESS EQUIPMENT, published on Jan. 5, 2023, and U.S. patent application Ser. No. 18/466,926 titled ELECTRIC FULL BODY FITNESS EQUIPMENT, filed on Sep. 14, 2023, the entire disclosures of which are incorporated herein by reference.

Advantageously, the voice command system can permit the user to interact with the exercise system, via, for example, a smart device app, without requiring that the user pause or stop working out to do so. Alternatively to stopping the workout and picking up the smart device to change and/or check a parameters related to the workout, the user can vocalize commands to the smart device and the smart device can alter the workout according to the command. As described herein, the exercise system and the voice command system can achieve this purpose by being connected to each other via Bluetooth™ or any other connectivity protocol, as desired.

The knob can be configured to run or modify the exercise setting of the resistance assembly specified by the user via the voice command system. It should be appreciated that the knob can be used to adjust an exercising setting, such as increasing or decreasing the resistance, of the resistance assembly. The knob can be disposed on an exterior of the exercise system to allow for the user to circumvent using the voice command system to adjust the current exercise setting to the new exercise setting however, in a preferred embodiment, the knob can be disposed within the interior of the exercise system to militate against the user adjusting without using the voice command system. The knob can be manipulated manually or mechanically, according to various embodiments.

The motor can be configured to adjust the knob and can receive instructions from the firmware. The motor can be selectively engageable with other operational parts of the exercise system such as a spool or gearbox, as examples, and can be configured to generate a resistance force. The motor can be configured to rotate the knob in either a clockwise or counterclockwise direction as required to adjust the knob from the current workout setting to the new workout setting. The motor can provide variable torque to the exercise system and in this way, provide the resistance required by the user for using the exercise system. As the resistance is adjusted by the user request, the motor can provide an instantaneous adjustment in the torque. As a non-limiting example, the motor can include a brushless DC (BLDC) motor. It should be further appreciated that one skilled in the art can employ a different motor, as desired.

The exercise system can include firmware. The firmware can operate the structure components of the exercise system and instruct the operational components of the exercise system, such as the motor, to make adjustments or movements. The firmware can read the position of internal parts of the exercise system such as a resistance knob by using a potentiometer. In operation, the firmware can receive the voice command from the instruction module. The firmware can then read the position of knob in the current workout setting and instruct the motor to move the knob to the new workout setting. The firmware can read the new workout setting of the knob and communicate to the instruction module that the knob has been adjusted to the new workout setting.

As described herein, the voice command system, including the voice capture module, the instruction module, and the user interface module, can be housed separately from the exercise system such that the voice command system is integrated into a personal device and in communication with the exercise system via a network. As a non-limiting example, the personal device can include a smart device, a tablet, a personal computer device, a wearable device such as a smartwatch or fitness tracker, a home assistant device, a smart speaker system, a smart home device, a gaming console, a medical device, or a smart appliance. In a particular embodiment, the personal device can include a smart phone application (app). However, the voice command system can be integrated with the exercise system, as desired. Where the voice command system is housed separately from the exercise system, the voice command system can be in communication with the exercise system via a network such as WIFI connection, a Bluetooth™ connection, or any other connectivity protocol, for example.

The voice capture module can be configured to capture a user instruction, in the form of a voice command, for one of a current workout setting and a new workout setting. It should be appreciated that the exercise device can include a microphone in communication with the voice capture module. The microphone can be internal to the exercise system. Alternatively, the voice capture module can be separate from the exercise system and wirelessly connected to the exercise system via a network such as WIFI connection, a Bluetooth™ connection, or any other connectivity protocol, for example and as described hereinabove.

The instruction module can be in communication with the voice capture module and the firmware. The instruction module can provide the voice command to the firmware to adjust the knob from the current workout setting to the new workout setting when the current workout setting and the new workout setting are different. The instruction module can send status updates to the user interface module. The user interface module can be configured to communicate status updates sent by the instruction module of the exercise system to the user. The user interface module can be configured to allow the user to view a preprogrammed cycle along with weight amounts and workout duration and can communicate the selected workout cycle and specifics to the instruction module. The user interface module can be an app on a smart device or, alternatively, the user interface module can be integrated with the exercise system. As a non-limiting example, the instruction module can be an artificial intelligence (AI) chip. The AI chip can be configured to capture a user instruction for one of the current workout setting and the new workout setting and communicate the user instruction to the firmware.

The exercise system can include a sensor. The sensor can be configured to measure workout data. Non-limiting examples of the workout data may include a current weight the user is experiencing, a number of rotations of the gearbox shaft, and a speed of the rotation of the gearbox shaft. The sensor can be in communication with the firmware to allow for the firmware to ascertain the difference between the new workout setting and a current workout setting of the exercise system and to move the exercise system from the current workout setting to the new workout setting. The sensor can relay to the firmware and, in turn, the instruction module that this change has occurred. The sensor can include a contact wiper and a hall sensor with a magnet. The contact wiper can be configured to determine a current position of a knob of an adjustable resistance means, such as a braking mechanism. Advantageously, this can allow the sensor to detect the current weight the user is experiencing by determining the current position of the knob.

The present disclosure also provides a method for using a voice command to instruct an exercise system. The user can stand on or next to the exercise device and begin a current workout. The current workout can include a current workout setting at resistance level 5, for example. Where the user wishes to change from the current workout setting to a new workout setting, the user can speak a user command to the exercise system. For example, the user command can include “increase resistance to resistance level 7.” Internally, the exercise system can adjust the resistance from the current workout setting of resistance level 5 to the new workout setting of resistance level 7. The exercise system can relay to the user via the interface module that the exercise device is now in the new workout setting, in this example, resistance level 7. The user can continue with their workout at the new workout setting.

In another example, the user can stand on or next to the exercise device and speak a user command to the exercise system. For example, the user command can pertain to a preprogrammed cycle such as “start exercise cycle 3.” The interface module can prompt the user to select a desired weight and duration for the preprogrammed cycle. The user can respond to the exercise device with the desired weight and duration such as “10 pounds for 4 minutes.” Internally, the exercise system can adjust to provide 10 pounds of resistance and set a 4-minute timer. The exercise system can relay to the user via the interface module that the exercise device is now ready for exercise cycle 3 and provide the user with an instructional video. The user can begin exercise cycle 3.

Advantageously, the voice command system and method can allow for the user to change the resistance during a workout without having to stop the workout. Additionally, the voice command system and method can allow for the user to quickly switch between preprogrammed cycles and further customize the preprogrammed cycles to fit their specific workout needs.

### EXAMPLES

Example embodiments of the present technology are provided with reference to the several figures enclosed herewith.

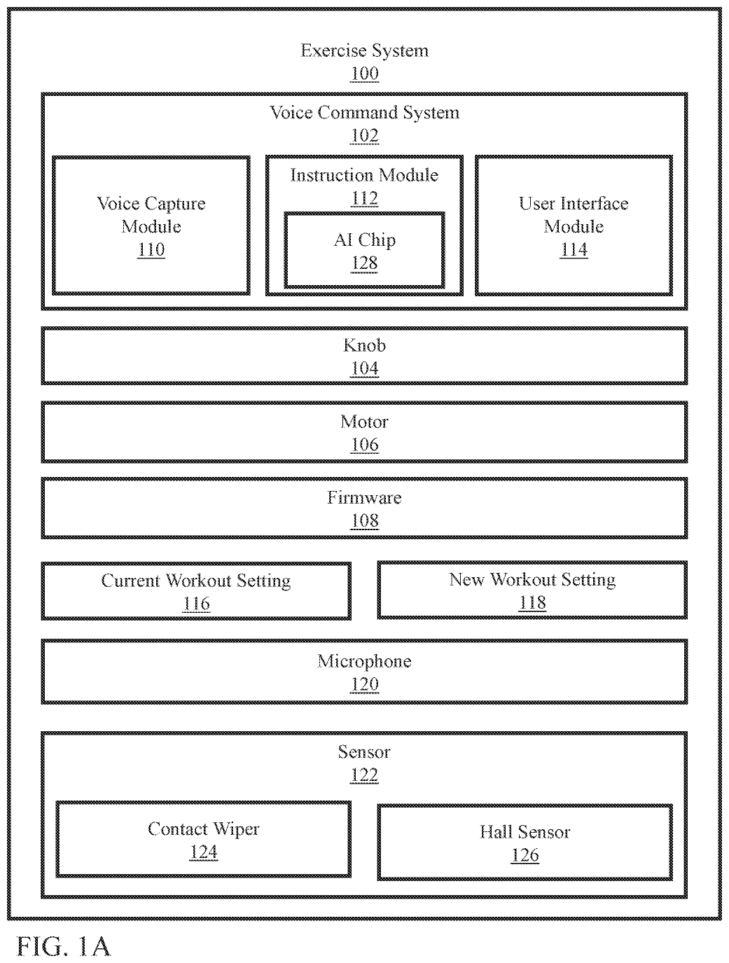

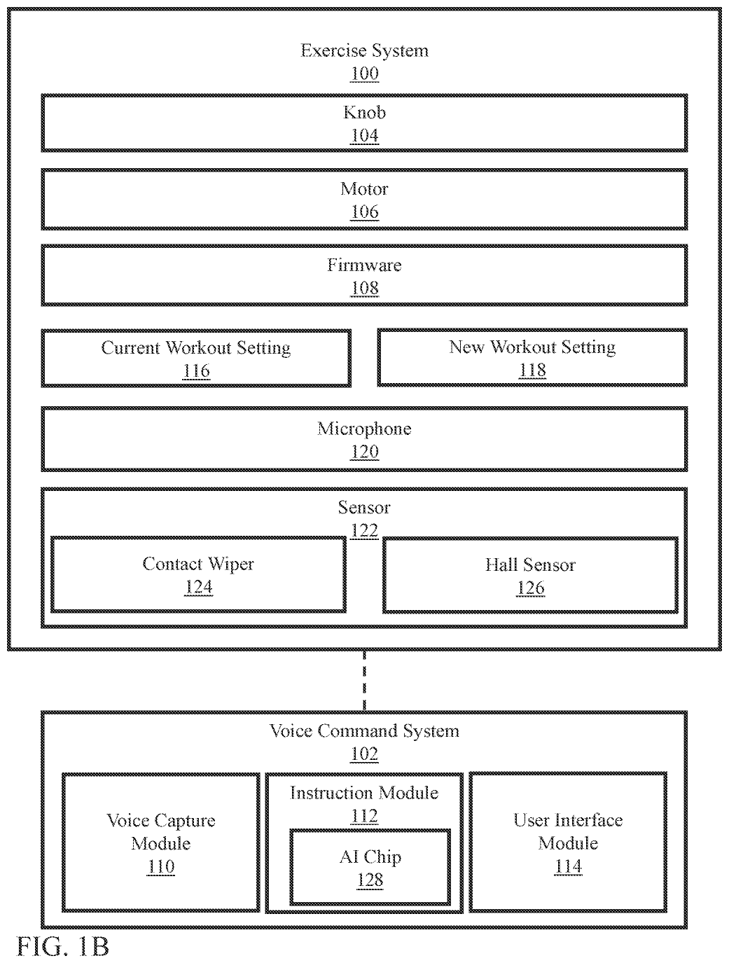

With reference to FIG. 1A, a first embodiment of a voice command system 102 for an exercise system 100 is shown. The exercise system 100 can include a knob 104, a motor 106, firmware 108, and the voice command system 102. The voice command system 102 can include a voice capture module 110, an instruction module 112, and a user interface module 114. The voice capture module 110 can be configured to capture a user instruction for one of a current workout setting 116 and a new workout setting 118. The voice capture module 110 can include a microphone 120. The microphone 120 can be disposed within the exercise system 100. Alternatively, and as shown in FIG. 1B, the voice capture module 110 can be separate from the exercise system 100 and wirelessly connected to the exercise system 100 via a WIFI connection, a Bluetooth™ connection, or any other connectivity protocol, as desired and as described herein.

With continued reference to FIG. 1A, the exercise system 100 can include a sensor 122. The sensor 122 can be configured to measure workout data and the workout data can be communicated to the user interface module 114 to enable the user to track progress as the workout progresses. The sensor 122 can include a contact wiper 124 and a hall sensor 126 having a magnet. The contact wiper 124 can be configured to determine a current position of a knob 104 of an adjustable resistance means (not shown) of the exercise system 100, such as a braking mechanism.

As shown in FIG. 1A, the exercise system 100 can include firmware 108. The firmware 108 can instruct operational parts of the exercise system 100, such as the motor 106 to move in a particular way specific to the user instruction or voice command given by the user. The firmware 108 can read the position of internal parts of the exercise system 100, such as a resistance knob, using a potentiometer. As an example, the instruction module 112 can be an artificial intelligence (AI) chip 128 configured to communicate with the voice capture module 110 and communicate workout information from the voice capture module 110 to the firmware 108.

The instruction module 112 can send status updates to the user interface module 114. The user interface module 114 can be configured to communicate status updates sent by the instruction module 112 of the exercise system to the user. The user interface module 114 can be configured to allow the user to select a preprogrammed cycle along with weight amounts and workout duration and can communicate the selected workout cycle and specifics to the instruction module 112. In one embodiment, the user interface module 114 can be an app on a smart device.

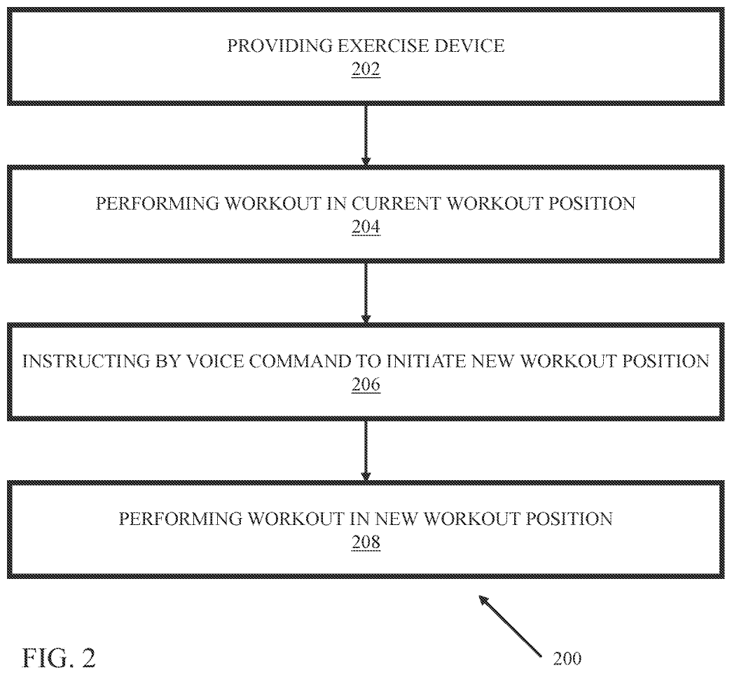

With reference to FIG. 2, a first exemplary method 200 of using a voice command to instruct an exercise system 100 is shown, where the voice command is given by a user completing a workout using the exercise system 100. In a step 202, an exercise system 100 having a voice command system 102, as described herein, can be provided. The user can use the exercise system 100 to perform a current workout with the exercise system 100 in a current workout setting 116 in a step 204. In a step 206, the user can audibly instruct the exercise system 100, by way of a voice command, to initiate a new workout setting 118. The user can perform a new workout with the exercise system in the new workout setting 118 in a step 208.

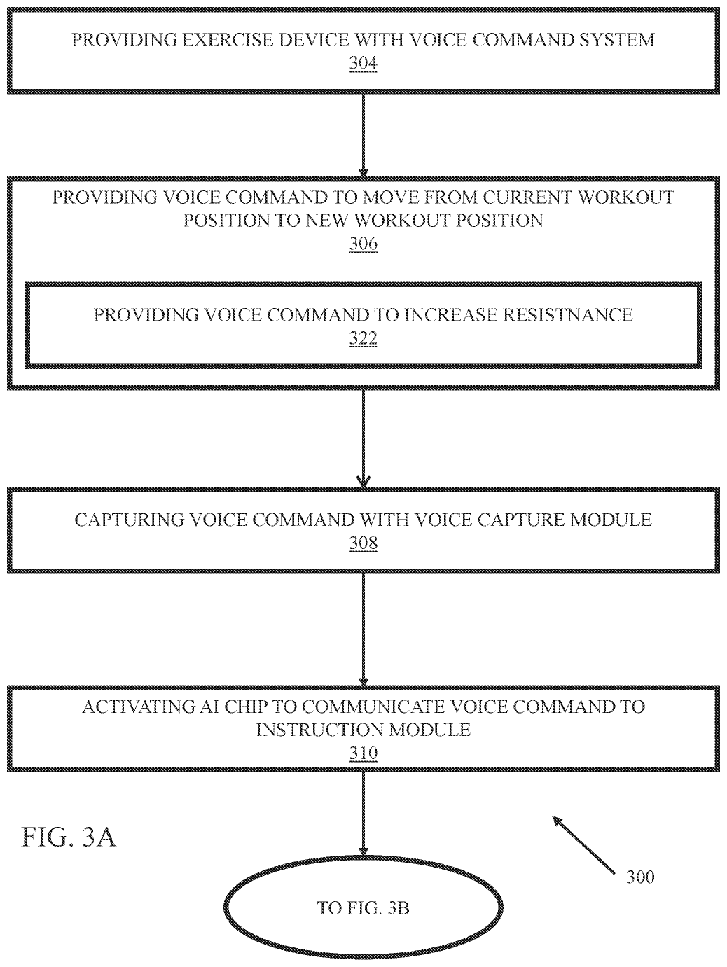

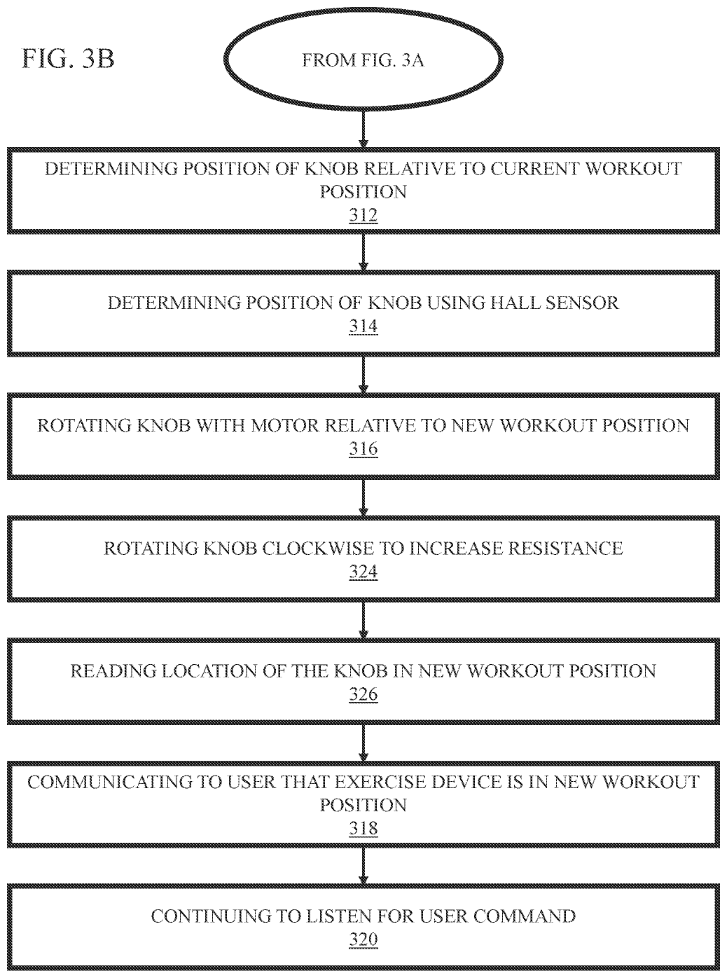

With reference to FIGS. 3A-3B, a second exemplary method 300 of using a voice command to instruct an exercise system 100 is shown. The method 300 can include a step 304 of providing an exercise system 100 with a voice command system 102 as described herein. In a step 306, the user can vocalize a voice command to move the exercise system from a current workout setting to a new workout setting. The voice command can include a keyword phrase. As an example, the keyword phrase can be associated with the term “resistance” such as “increase resistance” or “decrease resistance.”

In a step 308, the voice command can be captured with the voice capture module. The voice capture module can be enabled to listen for and collect the voice command. In a step 310, the AI chip 128 of the instruction module 112 can be activated to process and communicate the voice command to the instruction module 112.

The method 300 can include a step 312 of determining the position of the knob 104 of the exercise system 100 relative to the current workout setting 116 using the firmware 108. In certain embodiments and as described above, the exercise system 100 can include a hall sensor 126 for detecting the presence and magnitude of a magnetic field of the magnet, thereby allowing the number of rotations of the gearbox shaft and the speed of the rotation of the gearbox shaft to be determined by the sensor 122. As such, the method 300 can include a step 314 of determining the position of the knob with the hall sensor. As described herein, this determination of position can be done by the contact wiper. In a step 316, the knob 104 can be rotated by the motor 106 of the exercise system 100 and thereby the position of the knob 104 relative to the new workout setting 118 can be adjusted. The method can include a step 318 of communicating to the user that the exercise system is in the new workout setting 118 and can include a step 320 where the voice capture module 110 can continue to listen for the user instruction.

In the embodiment depicted in FIG. 3A, the method 300 can include a step 322 of the user providing a voice command to increase resistance. In a step 324, the instruction module 112 can rotate the knob 104 clockwise using the motor 106 of the exercise system 100 to increase the resistance of the exercise system 100 from the current workout setting 116 to the new workout setting 118. The instruction module 112 can use the potentiometer to read the location of the knob 104 for the new workout setting 118 in a step 326.

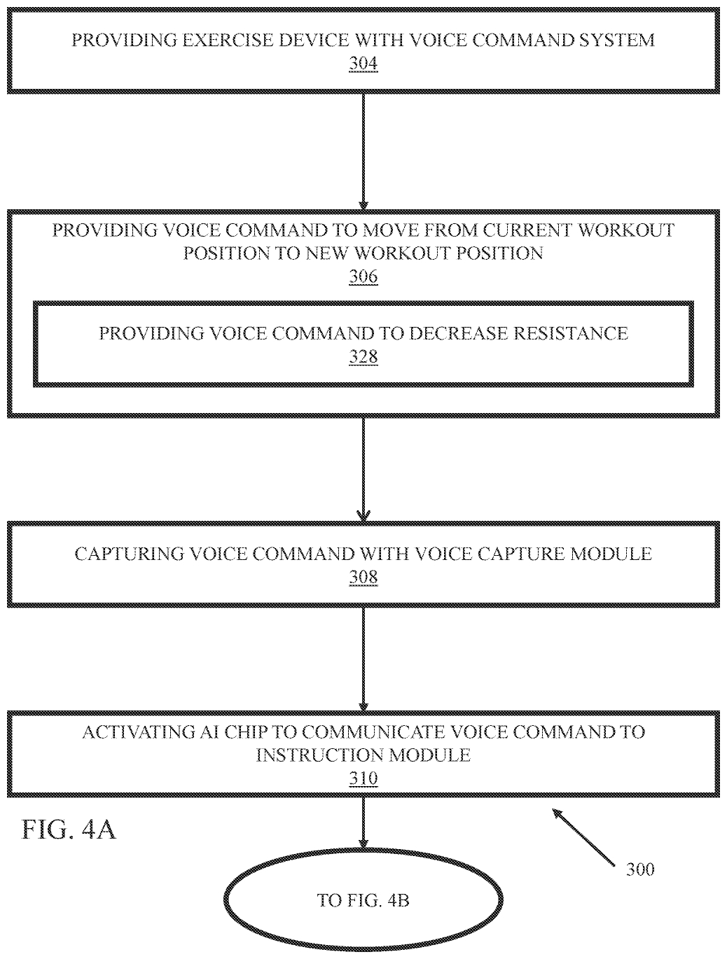

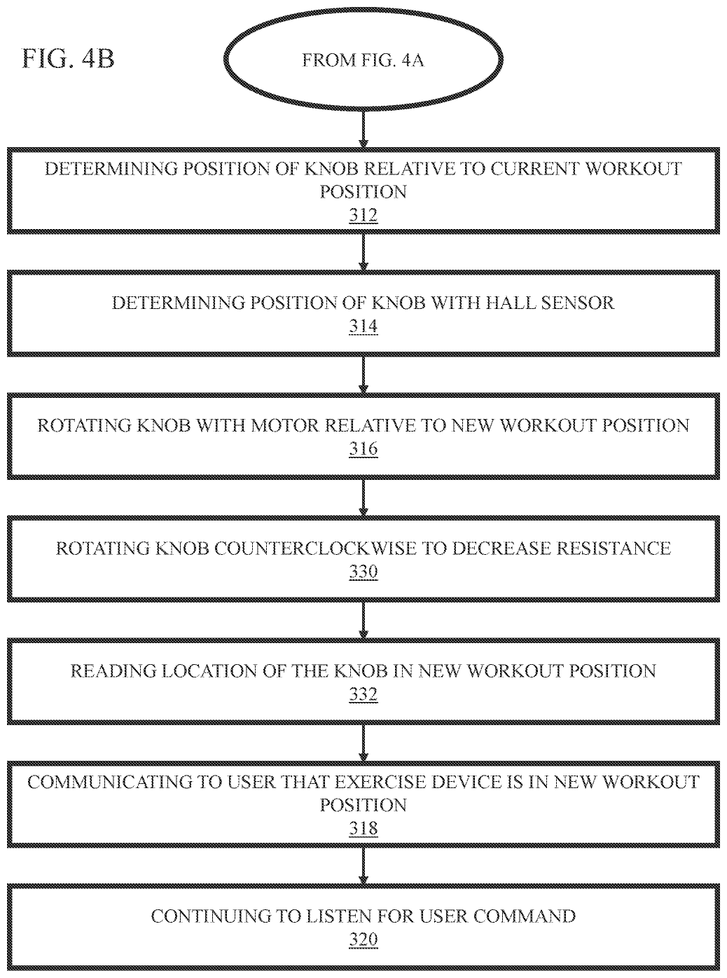

In an alternative embodiment shown FIGS. 4A-4B, the method 300 can include a step 328 of the user providing a voice command to decrease resistance. In a step 330, the instruction module 112 can rotate the knob 104 counterclockwise using the motor 106 of the exercise system 100 to decrease the resistance of the exercise system 100 from the current workout setting 116 to the new workout setting 118. The instruction module 112 can use the potentiometer to read the location of the knob 104 for the new workout setting 118 in a step 332.

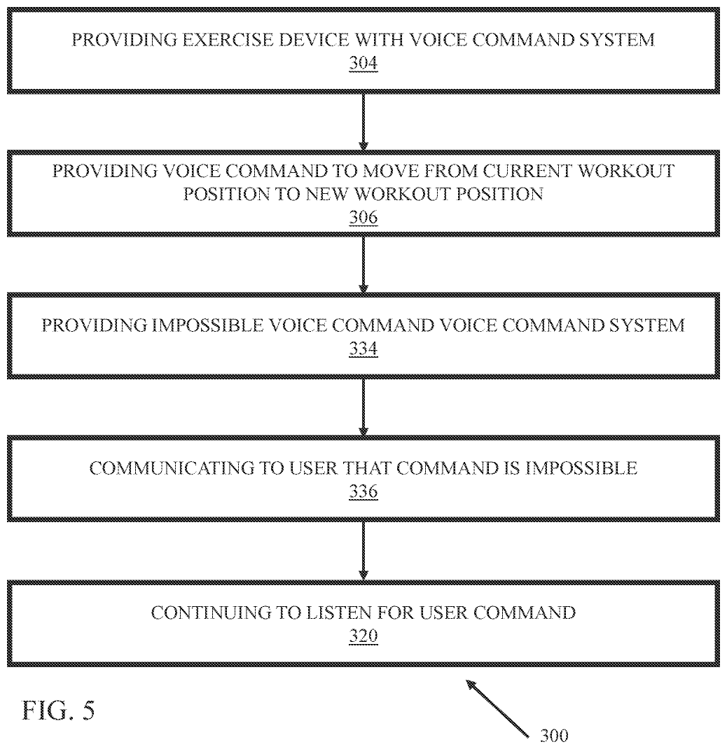

In a third exemplary embodiment shown in FIG. 5, the method 300 can include a step 334, where the user instruction is not possible for the instruction module 112 to execute. For example, the user can instruct the resistance to increase when the resistance is already in the highest position or the user can instruct the resistance to decrease when the resistance is already in the lowest position, both of which are instructions the instruction module 112 cannot execute. The exercise system 100 can communicate to the user that the instruction given cannot, and will not, be executed by the exercise system 100, in a step 336.

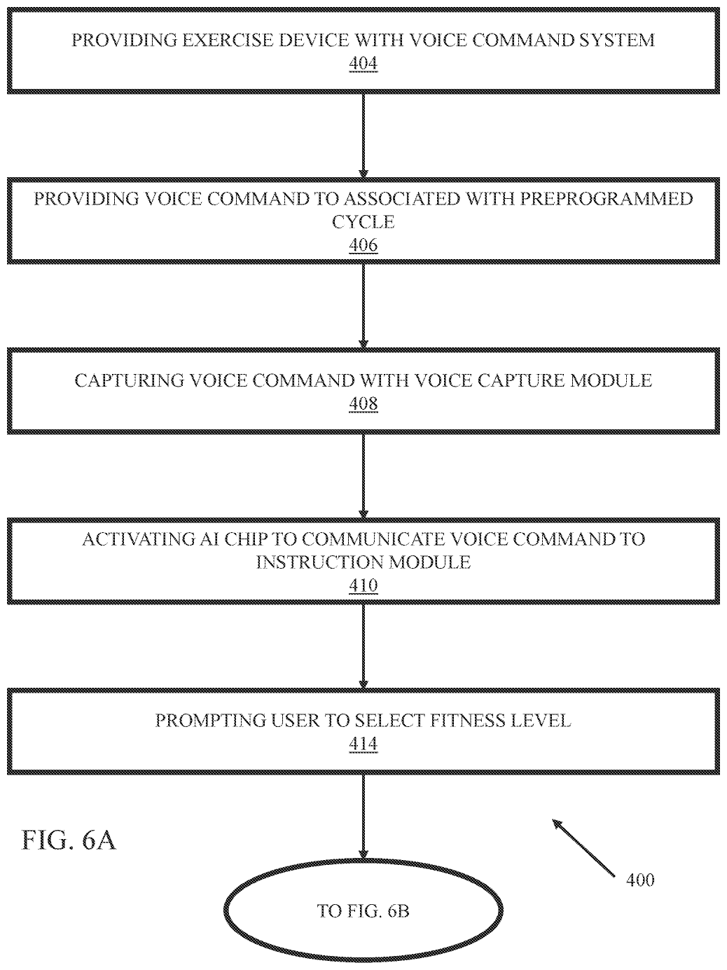

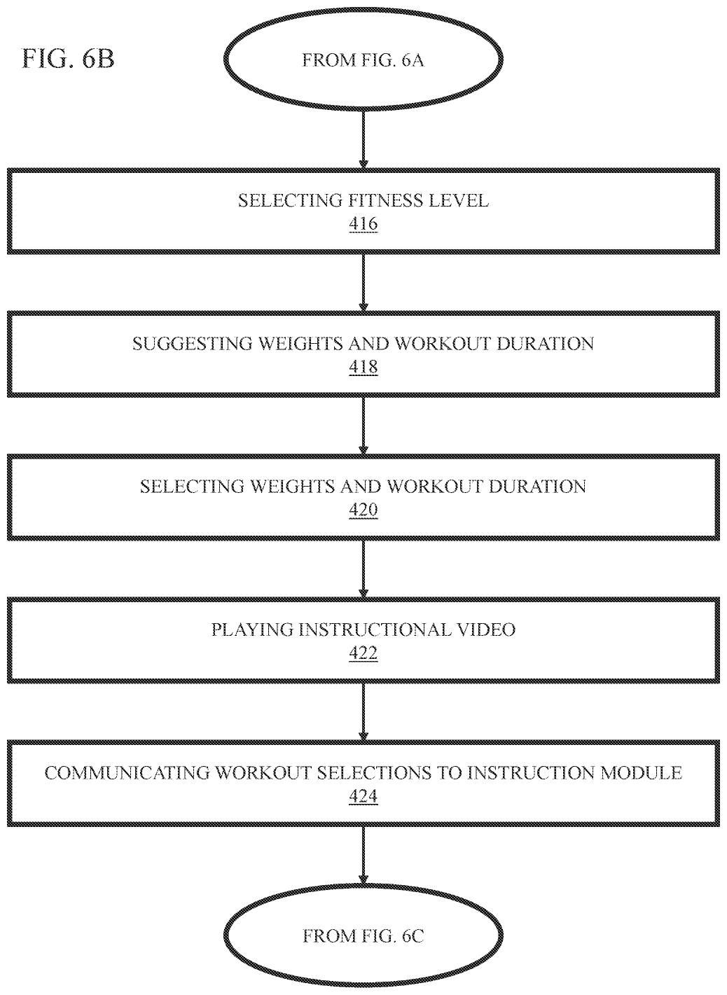

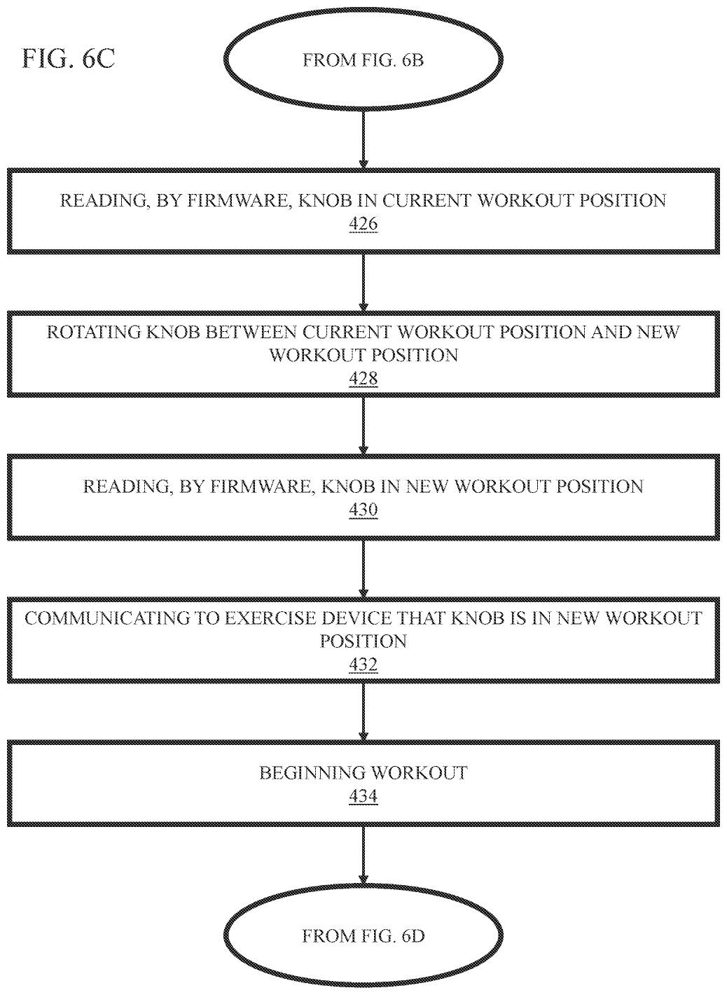

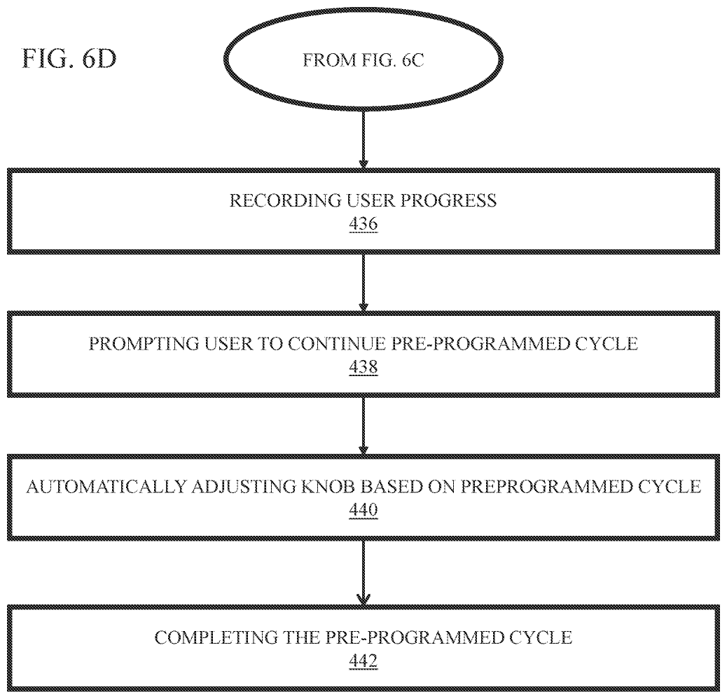

With reference to FIGS. 6A-6D, a fourth exemplary method 400 of using voice command to instruct the exercise system 100 is shown, where the voice command given is to start a pre-programmed cycle. The method 400 can include a step 404 of providing an exercise system 100 with a voice command system 102 as described herein. In a step 406, the user can say a keyword phrase associated with a preprogrammed cycle. In a step 408, the keyword phrase spoken by the user can be collected by a voice capture module 110. In a step 410, the AI chip 128 can be activated to process and communicate the voice command to the firmware 108.

The exercise system 100 can prompt the user to select a fitness level in a step 414. As an example, the fitness levels can include Beginner, Intermediate, and Advanced. In a step 416, the user can select the fitness level for their workout. The exercise system 100 can suggest recommended weights and workout duration and prompt the user to select from the recommended weights and workout duration in a step 418. In a step 420, the user can select their desired weight and workout duration. The exercise system 100 can play an instructional video that corresponds to the workout selected by the user in a step 422. It should be appreciated that in embodiments of the exercise system 100 that include the user interface module 114, the user interface module 114 can prompt the user to select the fitness level, suggest recommended weights and workout duration, prompt the user to select a weight and workout duration, and play the instructional video, as examples. A skilled artisan can select other suitable uses for the user interface module 114 as desired.

In a step 424, the exercise system 100 and, in certain instances, the user interface module 114, can communicate the workout selections picked by the user to the instruction module 112 of the exercise system. In a step 426, the firmware 108 can read a current workout setting 116 of a knob 104 using a potentiometer coupled to the knob 104. In a step 428, the firmware 108 can rotate the knob 104 using the motor 106 of the exercise system 100 clockwise to increase, or counterclockwise to decrease, the resistance of the exercise system 100 between the current workout setting 116 to the new workout setting 118. The firmware 108 can use the potentiometer to read the location of the knob 104 of the new workout setting 118 in a step 430. In a step 432, the instruction module 112 can communicate to the exercise system that the knob 104 is in the new workout setting 118 and that the resistance has been increased. In a step 434, the user can begin their selected workout. The user interface module 114 can start a recording of a hall sensor and rotating magnets readings in the exercise system to track the user as they progress through their selected workout in a step 436. In a step 438, when the user has completed the workout that the user selected, the exercise system 100 can prompt the user to continue with the pre-programmed cycle and desired workout specifics. The user can repeat the steps of beginning the workout and completing the workout that the user selected. In a step 440, the exercise device 100 can continue to automatically adjust the knob 104 based on the preprogrammed cycle selected. In a step 442, when the user has completed the workout that the user selected, the user can select to stop the preprogrammed cycle.

Advantageously, the voice command system 102 can permit the user to interact with the exercise system 100, via, for example, a smart device app, without requiring that the user pause or stop working out to do so. Alternatively to stopping the workout and picking up the smart device to change and/or check a parameters related to the workout, the user can vocalize commands to the smart device and the smart device can alter the workout according to the command. As described herein, the exercise system, voice capture module, and instruction module can achieve this purpose by being connected to each other via Bluetooth™ or any other connectivity protocol, as desired. Additionally, the methods 200, 300, 400 for using a voice command to instruct the exercise system 100 can assist the user in participating in an interruption free workout full of dynamic changes and responsive workouts.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. An exercise system having a voice command system, comprising:
a knob;
a motor configured to adjust the knob;
firmware configured to ascertain a difference between a new workout setting and a current workout setting; and
the voice command system including:
a voice capture module configured to capture a voice command for the new workout setting; and
an instruction module in communication with the voice capture module and the firmware, the instruction module configured to provide the voice command to the firmware to adjust the knob from the current workout setting to the new workout setting when the current workout setting and the new workout setting are different.

2. The voice command system of claim 1, wherein the voice command system includes a user interface module in communication with the instruction module and the voice command system configured to convey a status update of the exercise system to a user on the user interface module.

3. The voice command system of claim 1, wherein the instruction module includes an artificial intelligence (AI) chip configured to capture a user instruction for one of the current workout setting and the new workout setting and communicate the user instruction to the instruction module.

4. The voice command system of claim 1, wherein the exercise system includes a microphone.

5. The voice command system of claim 1, wherein the voice command system is configured to recognize a voice command to change to a resistance value.

6. The voice command system of claim 1, wherein the voice command system is configured to recognize a voice command to select a pre-programmed cycle.

7. A method for using an exercise system having a voice command system by a user, comprising:
providing exercise system having a voice command system including:
a knob,
a motor configured to adjust the knob,
firmware configured to ascertain a difference between a new workout setting and a current workout setting, and
the voice command system including:
a voice capture module configured to capture a voice command for the new workout setting, and
an instruction module in communication with the voice capture module and the firmware, the instruction module configured to provide the voice command to the firmware to adjust the knob from the current workout setting to the new workout setting when the current workout setting and the new workout setting are different;
performing, by the user, a current workout with the exercise system in the current workout setting;
instructing the exercise system with a voice command to initiate the new workout setting; and
performing, by the user, a new workout with the exercise system in the new workout setting.

8. A method for using a voice command system of an exercise system by a user, comprising:
providing the exercise system including:
a knob,
a motor configured to adjust the knob,
firmware configured to ascertain a difference between a new workout setting and a current workout setting, and
a voice command system including:
a voice capture module configured to capture a voice command for the new workout setting, and
an instruction module in communication with the voice capture module and the firmware, the instruction module configured to provide the voice command to the firmware to adjust the knob from the current workout setting to the new workout setting when the current workout setting and the new workout setting are different, the instruction module including an artificial intelligence (AI) chip configured to capture a user instruction for one of the current workout setting and the new workout setting and communicate the user instruction to the instruction module;
instructing the exercise system with the voice command;
capturing the voice command with the voice capture module;
activating the AI chip of the instruction module to process and communicate the voice command to the firmware;
determining, by the firmware, a position of a knob of the exercise system relative to the current workout setting;
adjusting the position of the knob to the new workout setting; and
communicating to the user that the exercise system is in the new workout setting.

9. The method of claim 8, wherein the exercise system further includes a sensor and the step of determining the position of the knob relative to the current workout setting further includes a step of determining the position of the knob with the sensor.

10. The method of claim 8, wherein the voice command to adjust from the current workout setting to the new workout setting includes a change to a resistance value.

11. The method of claim 10, wherein the voice command to adjust from the current workout setting to the new workout setting includes increasing the resistance value and the step of adjusting the position of the knob relative to the new workout setting further includes a step of rotating the knob clockwise using the motor.

12. The method of claim 10, wherein the voice command to adjust from the current workout setting to the new workout setting includes decreasing the resistance value and the step of adjusting the position of the knob relative to the new workout setting further includes a step of rotating the knob counterclockwise using the motor.

13. The method of claim 8, further including the step of instructing the exercise system with a voice command further includes the steps of:
prompting the user to select a preprogrammed cycle, including weight and duration of the preprogrammed cycle;
selecting a preprogrammed cycle; and
playing an instructional video corresponding to the preprogrammed cycle.

14. The method of claim 13, wherein the step of selecting the preprogrammed cycle includes selecting a fitness level.

15. The method of claim 14, wherein the step of selecting the preprogrammed cycle includes increasing the weight and the step of adjusting the position of the knob relative to the new workout setting further includes a step of rotating the knob clockwise using the motor.

16. The method of claim 14, wherein the step of selecting the preprogrammed cycle includes decreasing the weight and the step of adjusting the position of the knob relative to the new workout setting further includes a step of rotating the knob counterclockwise using the motor.

17. The method of claim 14, wherein the voice command system further includes a user interface module in communication with the instruction module, the user interface module configured to convey a status update of the exercise system to the user, and the step of prompting the user to select a preprogrammed cycle, including weight and duration of the preprogrammed cycle, further includes prompting the user on the user interface module.

18. The method of claim 8, wherein the voice command system further includes a user interface module in communication with the instruction module, the user interface module configured to convey a status update of the exercise system to the user, and the step of communicating to the user that the exercise system is in the new workout setting includes communicating via the user interface module.

19. The method of claim 13, further including a step of recording the selected preprogrammed cycle.

20. The method of claim 13, further including a step of automatically adjusting the knob using the knob based on the selected preprogrammed cycle.
